(19) United States
(12) Patent Application Publication
(10) Pub. No.: US 2007/0192315 A1
(43) Pub. Date: Aug. 16, 2007

(54) Database search with RFID

(76) Inventors: Paul S. Drzaic, Morgan Hill, CA (US); Curtis L. Carrender, Morgan Hill, CA (US); Raj Bridgelall, Plano, TX (US); John Price, Morgan Hill, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/706,046

(22) Filed: Feb. 12, 2007

Related U.S. Application Data
(60) Provisional application No. 60/773,007, filed on Feb. 13, 2006.

(51) Int. Cl. G06F 17/30

(52) U.S. Cl. 707/5

(57) ABSTRACT

Methods and apparatuses for extracting information from a database based on tag data are provided. One method includes interrogating a plurality of RFID tags coupled with objects within in an area to obtain tag data. The contextual environment of the area is determined based on the tag data. A search of a database relating to an item in the area is conducted. Relevance rankings of search results are adjusted based upon the determined contextual environment. Search results can be displayed in order of relevance rankings.

### RELATED APPLICATIONS

The present invention claims priority to the provisional application No. 60/773,007 titled “Database Search With RFID” filed on Feb. 13 2006, which is hereby incorporated as reference in its entirety.

### FIELD OF THE TECHNOLOGY

The present invention generally relates to the field of radio frequency identification (RFID) systems, and more particularly to techniques for retrieving remote database information relevant to an RFID tagged item.

### BACKGROUND

Goods and other items may be tracked and identified using an RFID system. An RFID system includes a tag and a reader. The tag is a small transponder typically placed on an item to be tracked. There are three basic types of RFID tags: passive (beam powered), semi-passive (battery powered), and active. The reader, sometimes referred to as an interrogator, includes a transceiver and an antenna. The antenna emits electromagnetic (EM) waves generated by the transceiver, which, when received by tag, activates the tag. Once the tag activates, it communicates using radio waves back to the reader, thereby identifying the item to which it is attached.

Due to size and cost constraints, tags use limited memory to store an identifier, such as an electronic product code. Nowadays, passive tags typically have 240 bits, 128 bits, or less of available memory, although tags with higher levels of memory can be constructed. Tags do not hold all desirable pieces of information about tagged items. However, real-time access to additional information by an RFID system could provide great benefits, such as increased efficiencies, better purchasing decisions, superior process handling, and improved safety.

Additional information relevant to an item may exist remotely on the Internet, a database, or other data depository. In many cases, this information will not be directly associated with a specific tag, thus making it difficult to determine the information's relevance. Another challenge is the vast quantity of additional information, such as what is available on the Internet. A conventional search engine can be employed to find information based upon user defined parameters (such as keywords), but without the advantage of a tag's real-world context for improved searching.

From the above it is seen that improved techniques to access and intelligently search remote databases for information relevant to a tag are desired.

### SUMMARY OF THE DESCRIPTION

Techniques for extracting information from a remote database based on tag data are provided. One or more RFID tags can be interrogated in an area to determine the contextual environment of the area. Contextual environment can be, without limitation, the nature or purpose of the area. That is to say, situational inferences can be made by the presence of certain objects or combinations thereof. Database searches are then adjusted to reflect the contextual environment to improve relevance of results.

In one embodiment of the present invention, a method is executed by at least one electronic device to extract information from a database. The method includes interrogating a plurality of RFID tags associated with objects within in an area. A contextual environment of the area is determined based on the objects. A first RFID tag coupled with a first item in the area is interrogated. The database is searched for information relevant to the first item. Relevance rankings of search results are adjusted based upon the contextual environment. Search results, or a portion thereof, can be displayed in order of a relevance ranking.

In another embodiment of the present invention, a method includes using at least one electronic device to interrogate an RFID tag associated with an item. The at least one electronic device is configured to operate in compliance with the radio frequency regulations of a country. A database is searched for information relevant to the item. Relevance rankings of search results are increased for results in the language of the country. Search results can be displayed in order of a relevance ranking.

In yet another embodiment of the present invention, a method includes interrogating an RFID tag coupled with an item. The RFID tag contains search information. At least one remote database is searched using the search information, and search results are displayed. In a specific embodiment, search information can include search engine parameters, pre-formed search queries, keywords, category information, hypertext link information, relevance ranking criteria, cookies, language preference, and search engine preference. Search information can also include advertising information (or references thereto), pricing information, or any other information relevant to commerce.

The present invention also discloses the concept of storing, in a tag, information associated with a product which is associated with the tag. For example, an RFID tag may contain information about the expiration date or the side effect of a drug. This information may be stored in the form of a vector, in the tag, which can guide an application program to access the expiration date or the side effect of the drug. In another instance, a tag associated with a product may store information such as language preference. In other examples, a first tag may store information about other tags, or that it can direct a reader to find other tags in proximity to the first tag.

Many benefits are achieved by way of the present invention. For example, the present technique can provide real-time access to a vast amount of database information relevant to an item, and improve searching of a database by taking into account the real-world contextual environment. In addition, a search engine provider can modify relevancy rankings of search results to promote a business partner of the search engine provider as a form of advertising. Depending upon the embodiment, one or more of these benefits, as well as others, may be achieved.

Various additional objects, features, and advantages of the present invention can be more fully appreciated with reference to the detailed description and accompanying drawings that follow.

### DESCRIPTION OF THE DRAWINGS

The present invention is illustrated by way of example and not limitation in the figures of the accompanying drawings in which like references indicate similar elements.

FIG. 1 illustrates an exemplary RFID system according to an embodiment of the present invention.

FIG. 2 shows a simplified method to query a database using RFID according to an embodiment of the present invention.

FIG. 3 shows a simplified method to query a database using RFID according to an embodiment of the present invention.

FIG. 4 illustrates an exemplary RFID system according to an embodiment of the present invention.

FIG. 5 shows a simplified block diagram of a reader according to an embodiment of the present invention.

FIG. 6 illustrates a simplified block diagram of a tag according to an embodiment of the present invention.

### DETAILED DESCRIPTION

The following description and drawings are illustrative of the invention and are not to be construed as limiting the invention. Numerous specific details are described to provide a thorough understanding of the present invention. However, in certain instances, well known or conventional details are not described in order to avoid obscuring the description of the present invention. References to one or an embodiment in the present disclosure are not necessarily references to the same embodiment; and, such references mean at least one.

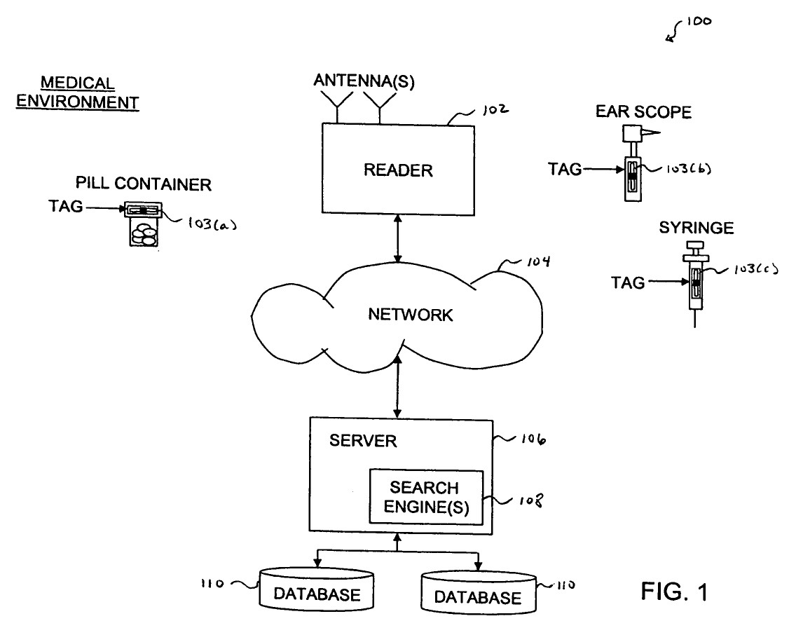

FIG. 1 illustrates an exemplary RFID system 100 according to an embodiment of the present invention. System 100 includes at least one reader 102 that can interrogate one or more tags (e.g., tags 103(a)-(c)) in relative proximity to it, such as within 1 meter, 5 meters, 10 meters, or more. Although reader 102 can be fixed (temporarily or permanently) to a predetermined location, it is preferred that reader 102 be portable, or even a wireless handheld device. Reader 102 interrogates tags 103(a)-(c) to read/write information, such as an electronic product code identifier or any other useful information.

Reader 102 couples to a communication network 104 which allows reader 102 to exchange data and information with other devices. Communication network 104 may be comprised of many interconnected computer systems and communication links. Communication network 104 may the Internet, a local area network (LAN), wide area network (WAN), metropolitan area network (MAN), a wireless network, a wireless LAN (WLAN), wireless wide area network (WWAN), a private network, a public network, a switched network, a cellular network, a satellite network, a global positioning system or the like. The interface between network 104 and reader 102 may be implemented using any recognized interface, for example RS-232, RJ-45, IEEE 802.11, or like. Similarly, any recognized communication protocol can be used to the exchange data (e.g., DHCP, TCP/IP, SNTP, or others).

Reader 102 can use tag data to access a specific information site over network 104. Tag 103(a) can store a “vector” to guide or direct an application program (e.g., a browser) to an Internet protocol (IP) address or a universal resource locator (URL) address. The application program can then retrieve information unique to the tagged item or information relevant to the category of the tagged item. For example, tag 103(a) can direct the application program to a site detailing manufacturing lot information (e.g., expiration date, date of manufacture, plant of manufacture, and the like). For certain uses requiring privacy, tag 103(a) may also store a password along with the vector to gain access to the site.

As illustrated in FIG. 1, communication network 104 also allows reader 102 to communicate with server 106. Server 106 is a device that manages network resources, or databases 110. Server 106 can be a dedicated database server or it may perform additional server functions. For example, server 106 can also be a file server for networked storage devices. In this instance, server 106 includes a search engine 108. Search engine 108 is a coordinated set of programs to find and organize information. These programs catalog searchable data stored in databases 110. A search query may be compared to the index to find relevant results. Search engine 108 can further include a crawler that looks for new data, such as updated files on network 104. It should be noted that searches of a structured directory of topics can be used in lieu of a search engine.

Accordingly, reader 102 can use tag data to search databases 110. Tags 103(a)-(c) can store search engine parameters, pre-formed search queries, keywords, category information, hypertext link information, relevance ranking criteria and the like. Tag data could also specify a preferred search engine to use, such as those offered by Google Inc., Yahoo! Inc., or Lycos, Inc. Tag data could even be used to write or overwrite a browser cookie. A cookie is information stored on a client side (e.g., browser) for future use, and typically records preferences when using a particular site.

As a specific example, if tag 103(a) is associated with a medicine containing the active ingredient loratadine, then tag 103(a) may store a complete, pre-formed search query, such as equivalent to performing a search query using terms “side” and “effect” and “loratadine” in a search engine such as “www.yahoo.com” or “www.google.com” to retrieve information on possible side effects. Reader 102 can read the pre-formed query from tag 103(a) and submit the pre-formed query to server 106. The search results can be then retrieved and displayed by reader 102. Alternatively, in this example, tag 103(a) may simply store keywords (e.g., “loratadine” and “side effect”) or store a natural language request.

A tag can also store a language preference. That is to say, tag data may specify a preference for results in English, Spanish, Mandarin, French, German, or other human intelligible language. Pre-formed queries can include language parameters to limit results. Results not in the preferred language specified by the tag may also be translated by reader 102.

Then again, instead of a tag, reader 102 can be programmed with a language preference. In such an instance, reader 102 can serve as a translation device. Tag data can include keywords that reader 102 translates and displays to a user. For example, if tag 103(a) stores the keywords “daily” for dosage information, it can be translated and displayed as “diario” in Spanish. The translation program can be installed on reader 102, or operate on a remote server.

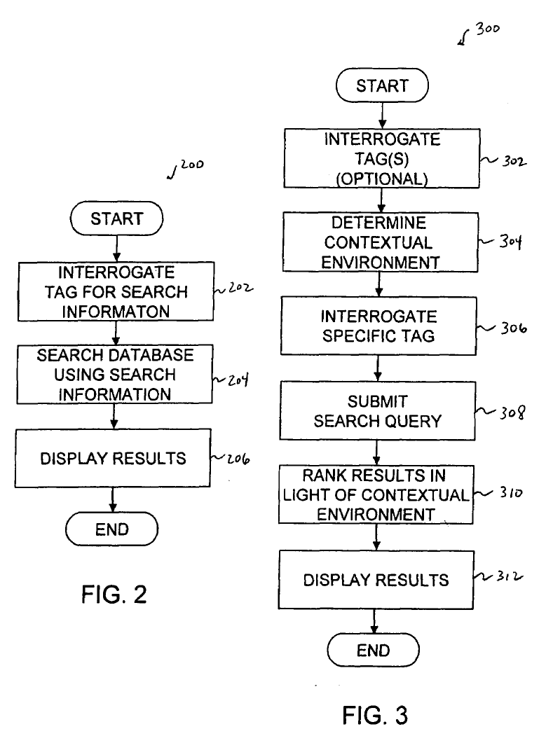

FIG. 2 shows a simplified method 200 for operating a system 100, according to one embodiment of the present invention. In step 202, reader 102 can interrogate a tag and retrieve information stored therein. This information can include one or more of a variety of information such as search engine parameters, keywords, hypertext link information, relevance ranking criteria and the like. Reader 102 communicates tag information via network 104 to search engine 108. In step 204, search engine 108 performs a search of a database 110 (or alternatively a structured directory) using the tag information. Search results can then be communicated back to reader 102, which may display the results in step 206.

For example, reader 102 reads tag 103(a) associated with a medical pill container. Data retrieved from tag 103(a) uniquely identifying the container is used by search engine 108 to query a database 110. Information about history, shelf life, recommended dosage, allergic reactions, side effects, or the like can be retrieved from database 110. On the other hand, the data retrieved from tag 103(a) may only provide limited identification (e.g., type, kind, or category information). In this event, search engine 108 can still be directed to locate pertinent information, such as dosage, side effects, etc. The data retrieved may also indicate a preference for a particular manufacturer or retailer for the tagged item, so that search engine results favor one or more particular business entities. Alternatively, the data retrieved may restrict or otherwise prefer search engine results from one or more sources of information. For example, a pharmaceutical database can be given higher priority than a medical news website (e.g., “www.cnn.com/HEALTH/”; “health.yahoo.com/”, etc.), which in turn can have a higher priority than a medical web blog.

FIG. 3 shows a simplified method 300 for operating a system 100, according to an alternative embodiment of the present invention. In step 302, a reader interrogates one or more tags to obtain information stored therein. Next in step 302, the system determines a contextual environment based on tag information. That is to say, the system deduces the likely environment of the reader and its proximate tags (e.g., medical facility, warehouse, retail store, grocery store, restaurant, factory floor, laboratory, home, work office, lavatory, or the like). The determination may be implemented by the reader as a standalone device or in communication with network devices and databases.

The reader can also be preprogrammed with its contextual environment, particularly if the reader remains in a fixed location. Otherwise, a system can determine contextual environment by using a global positioning system (GPS) system (with or without pseudolites) to determine position (e.g., latitude and longitude; or relative location) and correlating it with location information of businesses, establishments, and facilities. Fiducial tags, as discussed in U.S. patent application Ser. No. 11/040,551, entitled “Location Management for Radio Frequency Identification Readers,” which is incorporated herein, can also be used for location and context determination. Once location is known, physical location based queries can be performed. For example, searches can be initiated for transportation options from the location (e.g., taxi service telephone number, nearby bus stop locations, nearby subways stops, or route mapping). Searches can be arranged to favor particular types of transportation options, or exclude certain choices, depending on the context of the situation.

In step 306, reader interrogates a specific tag, such as tag 103(a), which will be the subject of a search engine query. A query is submitted to a search engine in step 308. The query can include any information stored on the specific tag or any information deduced from the contextual environment. Next, in step 310, the search engine finds pertinent information stored in one or more databases or directories. Relevance ranking of the search results can then be adjusted to reflect the context or weight of possible contexts, and displayed by the reader in step 312.

Referring back to FIG. 1 as an example, reader 102 can interrogate tags 103(a)-(c), and thus system 100 can determine that at least a pill container, ear scope, and syringe are in a predetermined area. Given that the combination of detected items is common to a medical facility, and generally uncommon elsewhere, system 100 may deduce that reader 102 is located in a hospital, clinic, or physician office. In this case, the contextual environment can be determined solely by interrogating one or more RFID tags within the vicinity of the reader rather than using the reader's location or preprogrammed contextual environment. The certainty of an accurate determination of contextual environment can be very high depending on the detected objects. Certain objects may generally only be found in medical facilities (e.g., a computerized tomography scanner, electrocardiogram monitor, or other medical equipment). Alternatively, system 100 can simply increase the weight given to medical environments over other possible environments.

The determination of contextual environment can be implemented using a priori knowledge or statistical information extracted from patterns. Pattern recognition techniques, such as neural networks, template matching, classification, feature extraction, cluster analysis, and the like can be used. In some embodiments, one or more sets of patterns that have already been classified can be used as a training set. Unsupervised learning can also be used, whereby the system establishes classes on its own based on statistical regularities of patterns.

In the event system 100 determines the context to be a medical facility in our example, search results relating to the pill container associated with tag 103(a) can be tailored for information useful in such context, like recommended dosage, side effects, poisoning treatment procedures, etc. It should be clear that in an alternative environment, such as in grocery store, the most pertinent information will differ (e.g., price, shelf life, recommended storing conditions). In this way, search results can be tailored to the contextual environment of a tagged item.

In one embodiment, at least a portion of information retrieved from a search can be stored to a first tag. In an alternative embodiment, first tag information can direct a reader to find other tags in proximity to the first tag. The first tag can store information about the other tags, or tags used to determine contextual environment.

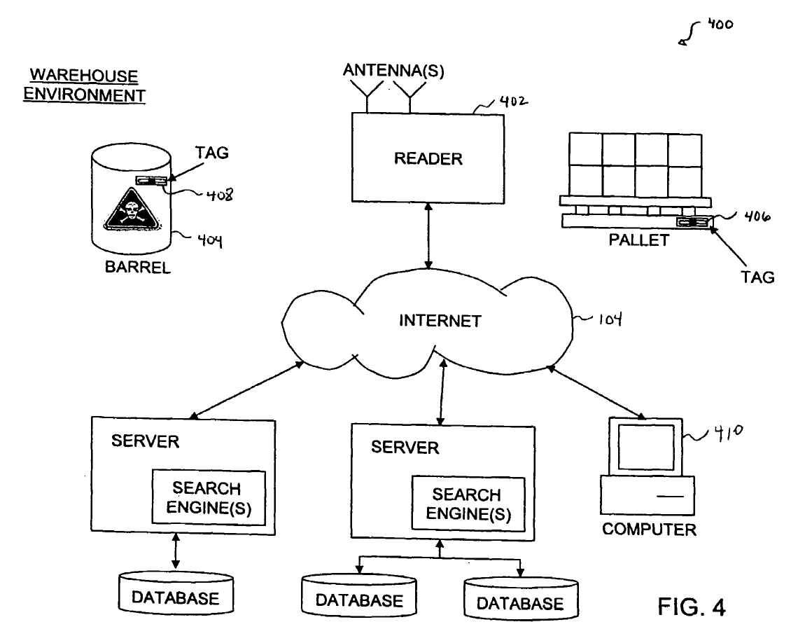

FIG. 4 illustrates a system 400 according to an embodiment of the present invention. System 400 includes a reader 402 disposed in a warehouse environment. Tags associated or coupled with objects typically found in warehouses can be interrogated by reader 402. As shown in FIG. 4, tags can be coupled to at least one barrel 404 or at least one pallet 406. Reader 402 may also interrogate tags coupled to pallet racks, fork lifts, crates, corrugated boxes, or fixtures (not shown).

Based on the teachings contained herein, system 400 can deduce its likely environment in order to enhance search results. For example, system 400 can determine reader 402 is located in a warehouse by the presence of pallet(s), barrel(s), or the combination thereof. System 400 can thus utilize environmental information to tailor the information retrieved from a database. Reader 402 can read tag 408 coupled to barrel 404. The information stored by tag 408 can identify barrel 404 to system 400, or other pertinent information (e.g., manufacturer name or website, hypertext links, keywords, etc.). System 400 can then access databases to retrieve relevant information to barrel 404 (e.g., safety handling procedures, contents, hazardous waste information, weight, or other information that may be need in a warehouse setting).

FIG. 4 also illustrates an additional feature of the present invention. A user on computer 410 can have remote access to reader 402. A real-time search of an area for items can be conducted and search query results from a database returned to the user. Reader 402 can also serve as a real-time data depository in lieu of a database. For example, a user can request a “software agent” list all barrels containing a specific substance in a predetermined area. The software agent can instruct reader 402 to read tag data, and then the agent may compare against a user's criteria, or against criteria set by the search engine provider or by some other interested party. The criteria may direct the agent to find tags and/or locations having certain physical characteristics. In other words, the software agent can be made to crawl an RFID network, the Internet, or other data depository to find items or data satisfying predefined criteria.

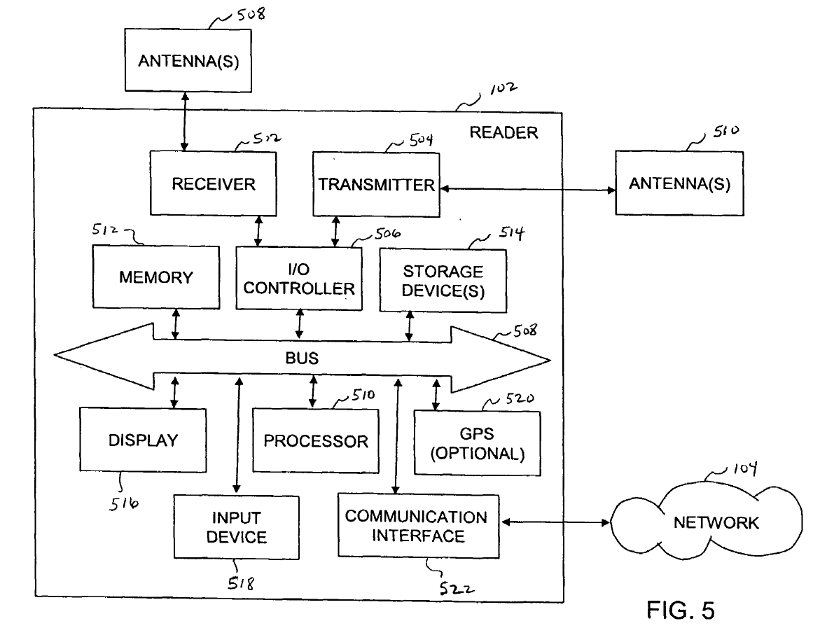

FIG. 5 shows an embodiment of a reader 102. Reader 102 typically includes a receiver 502 and a transmitter 504, each of which is coupled to an I/O (input/output) controller 506. The receiver 502 may have its own one or more antennas 508, and the transmitter 504 may have its own one or more antennas 510. It will be appreciated by those in the art that the transmitter 504 and the receiver 502 may share the same antenna provided that there is a receive/transmit switch which controls the signal present on the antenna and which isolates the receiver and transmitter from each other.

The receiver 502 and the transmitter 504 may be similar to conventional receiver and transmitter units found in conventional readers. The receiver and transmitter operate, in North America, in a frequency range of about 915 megahertz (e.g., 902 MHz-928 MHz). In Europe, the frequency range is about 866 megahertz (e.g., 865.7 MHz-867.7 MHz). Each is coupled to the I/O controller 506 which controls the receipt of data from the receiver and the transmission of data, such as commands, from the transmitter 504. The I/O controller 506 is coupled to a bus 508 which is in turn coupled to a processor 510, memory 512, one or more storage devices 514, display 516, input device 518, global positioning system (GPS) module 520, and communication interface 522.

There are various different possible implementations which may be used in the reader 102 for the processing system represented by these elements. In one implementation, the processor 510 is a programmable microcontroller, such as an 8051 microcontroller or other well-known microcontrollers or microprocessors (e.g. a PowerPC microprocessor) and memory 512 includes dynamic random access memory. Memory 512 may also include a non-volatile read only memory for storing data and software programs. The memory 512 typically contains a program which controls the operation of the processor 510 and also contains data used during the processing of tags, as in the interrogation of tags. In one embodiment, the memory 512 would typically include a computer program which causes the processor 510 to decode received tag data with the appropriate tag-to-reader protocol scheme, such as:

(i) EPCglobal Class I Generation 2 protocol,
(“www.epcglobalinc.com/standards_technology/EPCglobal2UHFRFIDProtocolV 109122005.pdf”);

(ii) EPCglobal Class I Generation 1 protocol,
(“www.epcglobalinc.com/standards_technology/Secure/v1.0/UHF-class1.pdf”); and

(iii) International Organization for Standardization (ISO) 18000-6,

which are each incorporated by reference herein for all purposes.

The reader 102 may also include a network interface, such as an Ethernet interface, which allows the reader to communicate to other processing systems through a network. The network interface would typically be coupled to the bus 508 so that it can receive data, such as the list of tags identified in an interrogation from either the microprocessor 510 or from the memory 512.

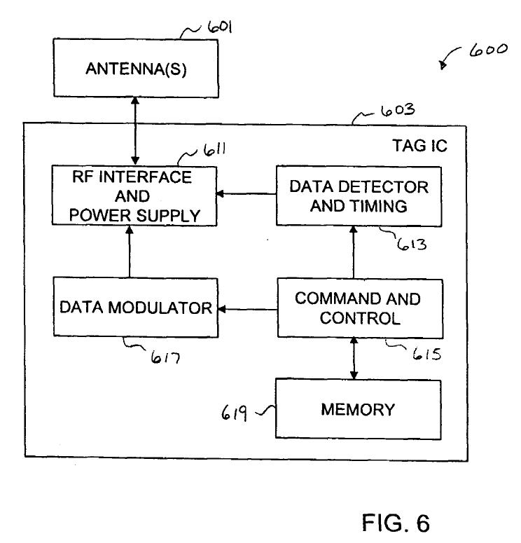

FIG. 6 shows an example of one implementation of a tag which may be used with the present invention. Tag 600 may be designed with a small integrated circuit (IC) area, small memory, atomic transactions to minimize tag state storage requirements, and the like. FIG. 6 shows an example of a low cost, passive tag 600. The tag 600 includes an antenna 601 and an integrated circuit 603, coupled together. Tag IC 603 implements the command protocol and contains stored tag information. The antenna 601 receives the reader interrogation signals and reflects the interrogation signal back to the reader in response to a modulation signal created by tag IC 603. The tag IC 603 combines an RF interface and power supply 611, data detector and timing circuit 613, command and control 615, data modulator 617 and memory 619. In one embodiment, command and control 615 may include static logic (such as a state machine) which implements communication protocols.

The RF Interface and Power Supply 611 converts the RF energy into the DC power required for the tag IC 603 to operate, and provides modulation information to the data detector and timing circuit 613. The RF interface also provides a means of coupling the tag modulation signals to the antenna for transmission to the reader. The data detector and timing circuit 613 demodulates the reader signals and generates timing and data signals used by the command and control 615, including a subcarrier sequence. The command and control 615 coordinates all of the functions of the tag IC 603. The command and control 615 may include state logic to interpret data from the reader, perform the required internal operations, and determine if the tag will respond to the reader. The memory 619 may contain an electronic product code, which may be associated with the tagged item. The data modulator 617 translates the binary tag data into a tag-to-reader encoded signal that is then applied to the RF interface 611 and transmitted to the reader (e.g., reader 401). In one embodiment, IC 603 is a NanoBlock™ IC manufactured by Alien Technology Corporation.

The design and implementation of tags can be characterized in layers. For example, a physical and environmental layer characterizes the mechanical, environmental, reliability and manufacturing aspects of a tag; a RF transport layer characterizes RF coupling between reader and tag; and, a communication layer characterizes communications/data protocols between readers and tags. Various different implementations of tags at different layers can be used with embodiments of the present invention. It is understood that the implementations of the tags are not limited to the examples shown in this description. Different tags or communication devices can use methods of the embodiments of the present invention for communication according to the needs of the particular application.

In one embodiment of the invention, a tag may be fabricated through a fluidic self-assembly process. For example, an integrated circuit may be fabricated with a plurality of other integrated circuits in a semiconductor wafer. The integrated circuit will include, if possible, all the necessary logic of a particular tag, excluding the antenna 601. Thus, all the logic shown in the tag 600 would be included on a single integrated circuit and fabricated with similar integrated circuits on a single semiconductor wafer. Each circuit may be programmed with a unique identification code and then singulated (and shaped) from the wafer. Integrated circuit blocks are next suspended in a fluid. The fluid is then dispersed over a substrate, such as a flexible substrate, to create separate tags. Receptor regions in the substrate would receive at least one integrated circuit, which then can be connected with an antenna on the substrate to form a tag. An example of fluidic self-assembly is described in U.S. Pat. No. 6,864,570, entitled “Method for fabricating self-assembling microstructures,” which is incorporated by reference herein. In another embodiment, a tag IC may be packaged as a flip chip which is attached to an antenna.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method executed by at least one electronic device for extracting information from a database, the method comprising:
interrogating a plurality of RFID tags coupled with objects within in an area;
automatically determining a contextual environment of the area based on the objects;
interrogating a first RFID tag coupled with a first item in the area;
searching a database for information associated with the first item;
adjusting relevance rankings of search results based upon the determined contextual environment; and
displaying search results in order of relevance rankings.

2. The method of claim 1 further comprising storing by the first RFID tag information retrieved from the search results.

3. The method of claim 1 wherein the determined contextual environment is at least one of a hospital, pharmacy, medical facility, warehouse, residential home, office, lavatory, laboratory, and factory floor.

4. The method of claim 1 wherein the first item is a medicine, and the adjusting increases the relevance rankings of search results describing a side effect, dosage amount, or active ingredient of the first item.

5. The method of claim 1 wherein the determined contextual environment is a warehouse, and the adjusting increases the relevance ranking of search results describing handling information of the first item.

6. The method of claim 5 wherein handling information includes at least one of storage temperature, shelf life, and hazardous material handing information.

7. The method of claim 1 wherein the determined contextual environment is a retail store, and the adjusting increases the relevance ranking of search results describing a product review, warranty, recall, rebate, or comparative pricing information of the first item.

8. A method executed by at least electronic device for obtaining information for an item, the method comprising:
interrogating an RFID tag coupled with the item, the RFID tag containing a web address;
directing a browser to the web address.

9. A method executed by at least one electronic device for extracting information from a database, the method comprising:
using the at least one electronic device to interrogate an RFID tag associated with an item, the at least one electronic device configured to operate in compliance with the radio frequency regulations of a predetermined country;
searching a database for the item;
increasing relevance rankings of search results in a predominant language of the predetermined country; and
displaying search results in order of relevance rankings.

10. The method of claim 9 wherein the predominant language is at least one of English, French, Spanish, Mandarin, and German.

11. The method of claim 9 wherein the searching of the database is conducted in a language other than the predominant language.

12. A method executed by at least one electronic device for extracting information from a database, the method comprising:
interrogating an RFID tag coupled with an item, the RFID tag containing search information;
searching at least one remote database using the search information; and
displaying search results.

13. The method of claim 12 wherein the search information includes at least one of a search engine query, a universal resource locator, and an indicator of preferred language.

14. The method of claim 12 wherein the search engine query indicates a web search company or directory company.

15. The method of claim 12 wherein the search information includes at least one keyword and at least one logical operator.

16. The method of claim 12 wherein the searching comprises submitting a query to a plurality of search engines and aggregating query responses as the search results.

17. The method of claim 12 wherein the search information includes modifiers for a relevancy algorithm and wherein the modifiers are capable of adjusting relevancy for a business partner.

18. The method of claim 12 wherein the search information includes machine-readable script for use with a search engine.

19. A method executed by at one least electronic device for extracting information from a database, the method comprising:
interrogating an RFID tag coupled with an item, the RFID tag containing a set of information;
searching a database using the set of information;
adjusting relevance rankings of search results based upon a determined contextual environment of the RFID tag; and
displaying search results in order of relevance rankings.

20. The method of claim 1 wherein the adjusting of relevance rankings is further based upon an identity of a source of the information.

21. The method of claim 17 wherein the relevancy algorithm includes factors to adjust relevancy based upon an identity of a source.
